(19) United States
(12) Patent Application Publication
(10) Pub. No.: US 2005/0185407 A1
(43) Pub. Date: Aug. 25, 2005

(54) Assembling apparatus for liquid crystal displays

(75) Inventors: Chung-Sung Huang, Miao-Li (TW); Eadle Chen, Miao-Li (TW); Xiao-Li Jin, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/064,042

(22) Filed: Feb. 22, 2005

(30) Foreign Application Priority Data
Feb. 20, 2004 (TW) 93104244

(51) Int. Cl. F21V 1/00

(52) U.S. Cl. 362/287

(57) ABSTRACT

An assembling apparatus (20, 50, 60) for liquid crystal displays includes a base plate (21), an angle adjustor (200) mounted on the base plate, and a working table (25, 55, 65) supported on the angle adjustor. The angle adjustor can adjust an angle of the working table relative to the base plate, so that operators can select a needed most convenient angle to assemble LCDs, not having to resort to using a different assembling apparatus.

### BACKGROUND OF THE INVENTION

1. Field of the Invention

The present invention relates to an assembling apparatus used to facilitate assembly of components of a product together, and particularly to an assembling apparatus used to hold and assemble components of a liquid crystal display (LCD).

2. Background of the Invention

A process of fabricating an LCD typically includes forming an LCD panel (known as a “cell process”), and assembling the LCD panel with other parts such as a backlight module, frame, etc. (known as a “modular process”). The modular process is generally accomplished using an assembling apparatus, which mainly has the functions of holding, turning over, and electrically testing the LCD under assembly.

Referring to FIG. 7, this shows a conventional assembling apparatus 10 for LCDs as disclosed in Taiwan Patent No. 488,594 issued on May 21, 2002. The assembling apparatus 10 includes a base frame 11, and a supporting plate 12 fixed to the base frame 11 at an oblique angle. The supporting plate 12 is generally rectangular, and defines two opposite cutouts 13. The cutouts 13 are used to expediently place an LCD (not shown) on the supporting plate 12 and lift the LCD off from the supporting plate 12. The supporting plate 12 further includes a flange 14 used to support the LCD.

Referring to FIG. 8, in use of the assembling apparatus 10, it is disposed on a horizontal working platform 17 in a clean booth 16 of a dustless working station 15. An angle A is defined between the supporting plate 12 and the working platform 17. An operator can conveniently work on an LCD at the desired angle A, which is set in the range from 25°˜65°.

However, the angle A is set at a fixed value. If the angle A needs to be changed, for example when a new operator of different stature uses the assembling apparatus 10, the assembling apparatus 10 must be dismantled and reconfigured. This is time-consuming, troublesome, and costly.

What is needed is an assembling apparatus with a readily adjustable supporting plate.

### SUMMARY

In a preferred embodiment, an assembling apparatus for liquid crystal displays includes a base plate, an angle adjustor mounted on the base plate, and a working table supported on the angle adjustor. The angle adjustor can adjust an angle of the working table relative to the base plate, so that operators can select a needed most convenient angle to assemble LCDs, not having to resort to using a different assembling apparatus.

Other advantages and novel features of the present invention will become more apparent from the following detailed description of preferred embodiments when taken in conjunction with the accompanying drawings, in which:

### BRIEF DESCRIPTION OF THE DRAWINGS

FIG. 1 is an isometric view of an assembling apparatus according to a first embodiment of the present invention;

FIG. 2 is an exploded view of the assembling apparatus of FIG. 1;

FIG. 3 is similar to FIG. 1, but showing a working table tilted relative to a base plate of the assembling apparatus;

FIG. 4 is an isometric view of an assembling apparatus according to a second embodiment of the present invention;

FIG. 5 is a side plan view of an assembling apparatus according to a third embodiment of the present invention;

FIG. 6 is a top plan of the assembling apparatus of FIG. 5;

FIG. 7 is an isometric view of a conventional assembling apparatus; and

FIG. 8 is an isometric of the assembling apparatus of FIG. 7 installed in a clean booth.

### DETAILED DESCRIPTION OF THE PREFERRED EMBODIMENTS

Reference will now be made to the drawings to describe the present invention in detail.

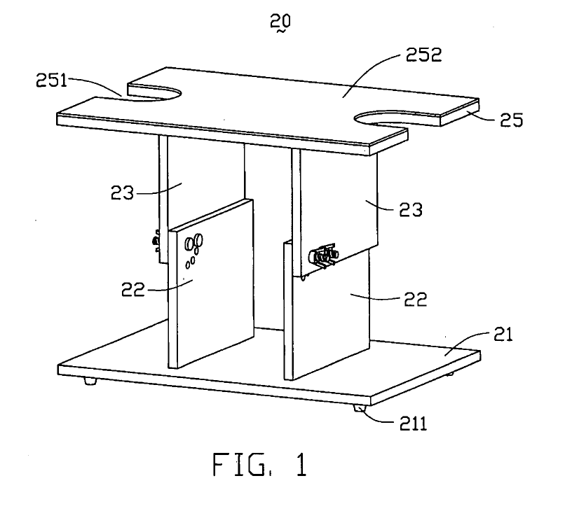

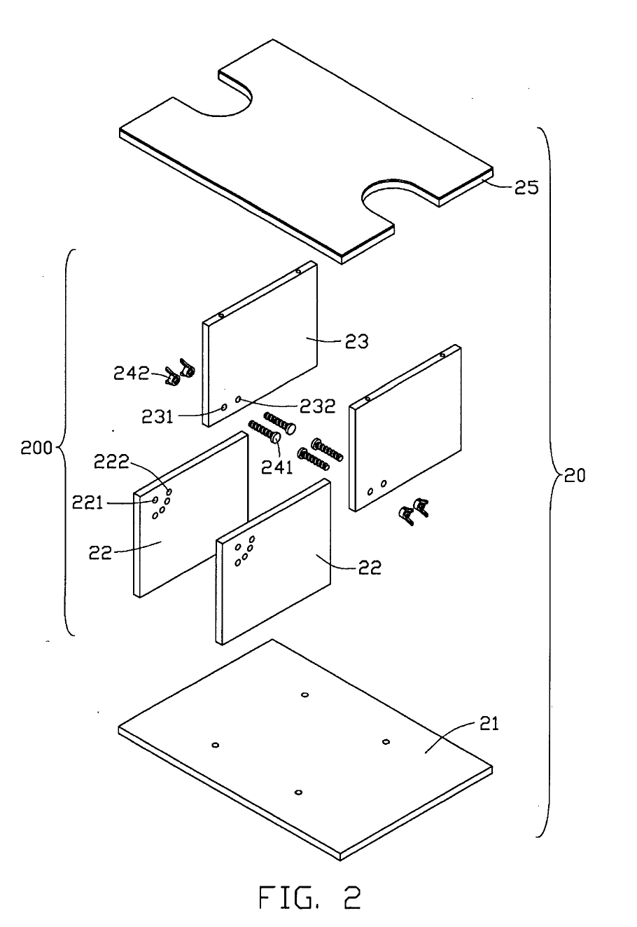

FIG. 1 is an isometric view of an assembling apparatus 20 according to the first embodiment of the present invention, and FIG. 2 is an exploded view thereof. In this embodiment, the assembling apparatus 20 includes a base plate 21, an angle adjustor 200 mounted on the base plate 21, and a working table 25 mounted on the angle adjustor 200. The angle adjustor 200 interconnects the working table 25 and the base plate 21, and is used to adjust the angle of the working table 25 relative to the base plate 21.

Four standoffs 211 are fixed to four comers of an underside of the base plate 21 respectively, for supporting the assembling apparatus 20 on a standard table (not shown). To prevent the standoffs 211 from sliding on the standard table or scratching a surface of the standard table, the standoffs 211 are made of rubber material.

Referring particularly to FIG. 2, the angle adjustor 200 includes two opposite first supporting plates 22, two opposite second supporting plates 23, and a plurality of locking devices (not labeled) used to fix the first supporting plates 22 and the second supporting plates 23 together. The first supporting plates 22 are vertically fixed on the base plate 21 by screws (not shown). Each of the first supporting plates 22 defines a first through hole 221 and a plurality of second through holes 222. The first through hole 221 is located in a front upper corner of the first supporting plate 22. The second through holes 222 are arranged in an arc around the first through hole 221. A top one of the second through holes 222 and the first through hole 221 are in a same horizontal plane. The second supporting plates 23 are vertically fixed to an underside of the working table 25 by screws (not shown). Each of the second supporting plates 23 defines a third through hole 231 and a fourth through hole 232. The third and fourth through holes 231, 232 are horizontally arranged in a front lower comer of the second supporting plate 23. A transverse distance between the third and fourth through holes 231, 232 is the same as a distance between the first through hole 221 and each second through hole 222. Each locking device includes a screw 241 and a wing nut 242, which cooperate to connect and fix the corresponding first supporting plate 22 and second supporting plate 23 together. The inclined angle of the working table 25 can be adjusted by aligning the third through hole 231 with the first through hole 221 and aligning the fourth through hole 232 with a desired second through hole 222.

The working table 25 defines two opposite first cutouts 251 which are used to expediently place an LCD (not shown) on the working table 25 and lift the LCD off from the working table 25. To protect the LCD from colliding with or rubbing the working table 25, a rubber cushion 252 is placed on the working table 25. The rubber cushion 252 can also prevent the generation of static electricity.

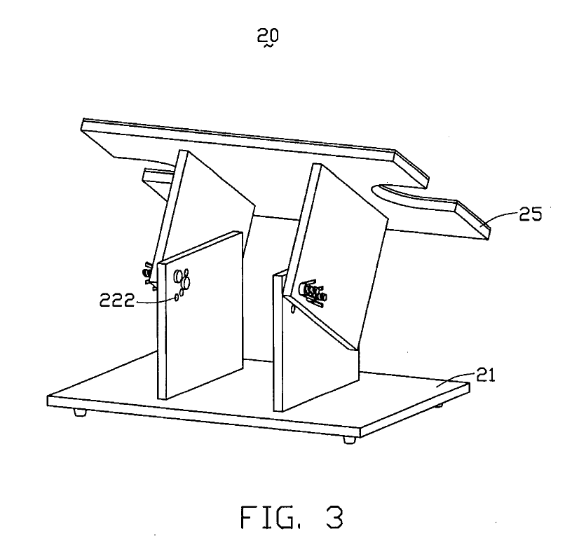

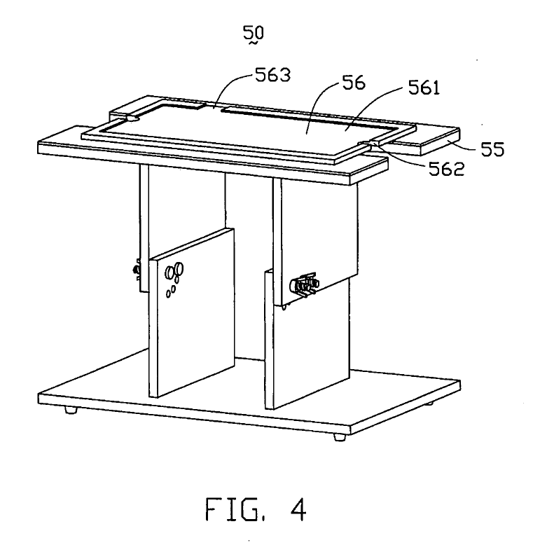

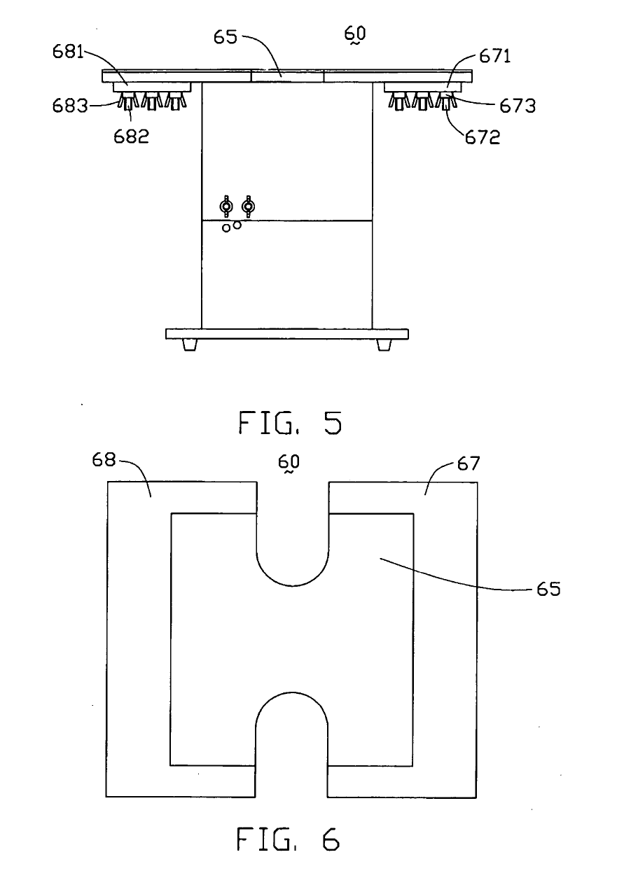

Referring to FIG. 3, this shows the assembling apparatus 20 having the working table 25 tilted relative to the base plate 21. When different second through holes 222 are selected to be aligned with the fourth through holes 232, the angle of the working table 25 relative to the base plate 21 is changed.

Because the angle of the working table 25 relative to the base plate 21 is easily adjusted, operators can select a needed most convenient angle to assemble LCDs, not having to resort to using a different assembling apparatus.

FIG. 4 is an isometric view of an assembling apparatus 50 according to the second embodiment of the present invention. In this embodiment, the assembling apparatus 50 has essentially the same structure as that of the assembling apparatus 20 of the first embodiment. However, the assembling apparatus 50 includes a holding device 56 placed on a working table 55. The holding device 56 defines a shallow, central recess 561 used to receive and hold an LCD. Two second cutouts 562 are defined at two opposite sides of the holding device 56 respectively. An opening 563 is defined in a peripheral wall of the holding device 56, in communication with the recess 561. A flexible printed circuit board (FPC) attached to the LCD can smoothly extend out of the holding device 56 through the recess 561, without being bent. The second cutouts 562 are used to expediently place the LCD in the recess 561 and lift the LCD out from the recess 561. With this configuration, when the size of the LCD is changed, a manufacturer need only change the holding device 56, with no need to change other parts of the assembling apparatus 50. Thus, the costs of mass production are reduced.

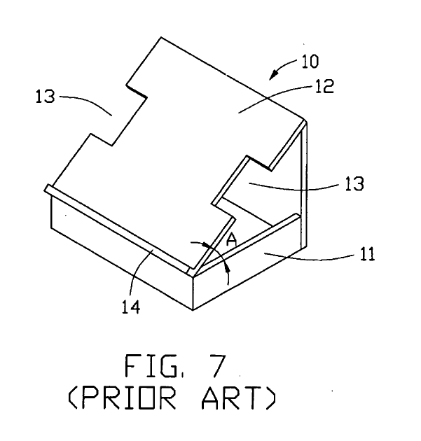

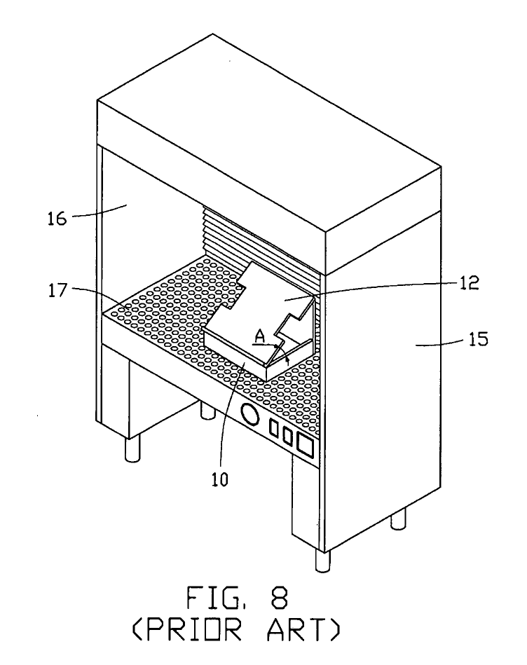

FIGS. 5 and 6 show an assembling apparatus 60 in accordance with the third embodiment of the present invention. In this embodiment, the assembling apparatus 60 has essentially the same structure as that of the assembling apparatus 20 of the first embodiment. However, the assembling apparatus 60 includes two expansion tables 67, 68 respectively fixedly connected with two opposite sides of a working table 65. A plurality of screws 672 extends down through the expansion table 67 and a connecting plate 671, respectively. A plurality of screws 672 extends down through the working table 65 and the connecting plate 671, respectively. A plurality of wing nuts 673 is attached on the screws 672, so that the expansion table 67 is fixedly connected with the working table 65 via the connecting plate 671. A plurality of screws 682 extends down through the expansion table 68 and the connecting plate 681, respectively. A plurality of screws 682 extends down through the working table 65 and the connecting plate 681, respectively. A plurality of wing nuts 683 is attached on the screws 682, so that the expansion table 68 is fixedly connected with the working table 65 via the connecting plate 681. The expansion tables 67, 68 and the working table 65 together constitute a larger table for placing and assembling of an LCD with a larger size.

The present invention may have other embodiments as follows. The number of the first supporting plates may be one, or more than two. Further, a gear configuration may replace the locking devices and through holes.

It is understood that the above-described embodiments are intended to illustrate rather than limit the invention. Variations may be made to the embodiments without departing from the spirit of the invention as claimed. The above-described embodiments illustrate the scope of the invention, but are not intended to restrict the scope of the invention.

1. An assembling apparatus, comprising:
an angle adjustor; and
a working table supported on the angle adjustor, wherein the angle adjustor can adjust an angle of the working table relative to the horizontal.

2. The assembling apparatus as recited in claim 1, further comprising a base plate, wherein the angle adjustor is mounted on the base plate.

3. The assembling apparatus as recited in claim 2, wherein the base plate comprises a plurality of standoffs fixed to an underside thereof, for supporting the assembling apparatus on a surface.

4. The assembling apparatus as recited in claim 3, wherein the standoffs are made of rubber material.

5. The assembling apparatus as recited in claim 1, wherein the working table comprises a rubber cushion placed thereon, for buffering a liquid crystal display placed thereon and for preventing the generation of static electricity.

6. The assembling apparatus as recited in claim 1, wherein the angle adjustor comprises a first portion and a second portion rotatably connecting with the first portion.

7. The assembling apparatus as recited in claim 6, wherein the second portion connects with the first portion through a screw configuration.

8. The assembling apparatus as recited in claim 1, wherein the angle adjustor comprises a first supporting member, a second supporting member, and a pair of locking devices, the first supporting member defines a first through hole and a plurality of second through holes, the second through holes are arranged in an arc around the first through hole, the second supporting member connects with the working table, and defines a third through hole and a fourth through hole, and the locking devices are used to fix the first supporting member and the second supporting member together at the first through hole and the third through hole, and at a selected one of the second through holes and the fourth through hole.

9. The assembling apparatus as recited in claim 8, wherein each of the locking devices comprises a screw and a nut, the screw extending through the first through hole and the third through hole, or through the selected one of the second through holes and the fourth through hole, and the nut engaging on the screw.

10. The assembling apparatus as recited in claim 1, wherein the working table defines a cutout, for expediently placing a liquid crystal display on the working table and lifting the liquid crystal display off from the working table.

11. The assembling apparatus as recited in claim 1, further comprising a holding device placed on the working table, the holding device being for receiving and holding a liquid crystal display thereon.

12. The assembling apparatus as recited in claim 1, further comprising an expansion table, the expansion table and the working table together constituting a larger table.

13. An assembling apparatus, comprising:
an upper portion; and
a lower portion;
wherein an angle of the upper portion relative to the lower portion is adjustable through a screw configuration.

14. An assembling apparatus comprising:
a working table supported above an angle adjustor; and
at least one notch defined in an edge of said working table; wherein
said angle adjustor defines a rotation axis so as to have the working table tilted relative to a horizontal plane.

15. The assembling apparatus as claimed in claim 14, wherein said working table defines a lengthwise side and a transverse side, under a condition that said lengthwise side extends along said rotation axis and said notch is located in said transverse side.
